(19) United States
(12) Patent Application Publication
(10) Pub. No.: US 2019/0072114 A1
(43) Pub. Date: Mar. 7, 2019

(54) Planter Down Pressure And Uplift Devices, Systems And Associated Methods

(71) Applicant: Ag Leader Technology, Ames, IA (US)

(72) Inventors: Allen Myers, Ames, IA (US); Douglas Gilbert, Ames, IA (US)

(21) Appl. No.: 16/121,065

(22) Filed: Sep. 4, 2018

Related U.S. Application Data
(60) Provisional application No. 62/553,744, filed on Sep. 1, 2017.
(60) Provisional application No. 62/595,112, filed on Dec. 6, 2017.

(51) Int. Cl. F15B 11/16; A01C 7/08; A01B 63/32; F15B 15/06

(52) U.S. Cl. CPC F15B 11/16; A01C 7/08; F15B 1/027; F15B 15/06; A01B 63/32

(57) ABSTRACT

The disclosed apparatus, systems and methods relate to devices, systems and methods for the selective application of down pressure or downforce to a row unit. Each row unit has a dual-action actuator which is in fluidic communication with the hydraulic system for independent control of the supplemental downforce. The pressure line can be directly routed to the lift chamber for a constant supply of up pressure, with down pressure selectively applied to the down chamber for accurate control of the supplemental downforce system.

### CROSS-REFERENCE TO RELATED APPLICATION(S)

This application claims priority to U.S. Provisional Application No. 62/553,744 filed Sep. 1, 2017 and U.S. Provisional Application No. 62/595,112 filed Dec. 6, 2017 which are hereby incorporated by reference in their entirety under 35 U.S.C. § 119(e).

### TECHNICAL FIELD

The disclosed technology relates generally to devices, systems and methods for use in high speed planting, and in particular, to the devices, methods, and design principles allowing for the application of down pressure to individual row units. This has implications for high speed, high yield planting of corn, soy beans and other agricultural crops.

### BACKGROUND

The disclosure relates to apparatus, systems and methods for use in high speed planting applications.

There is a need in the art for improved, efficient systems for the application of net down pressure to individual row units via hydraulic components in fluidic communication with the hydraulic chambers of individual actuators.

### BRIEF SUMMARY

Discussed herein are various devices, systems and methods relating to a system for the application of down pressure to an individual row unit. In these implementations, only two hoses need to be used between each control valve block, versus three with other systems.

In certain Examples, a system of one or more computers can be constructed and arranged to perform particular operations or actions by virtue of having software, firmware, hardware, or a combination of them installed on the system that in operation causes or cause the system to perform the actions. One or more computer programs can be constructed and arranged #2997479 to perform particular operations or actions by virtue of including instructions that, when executed by data processing apparatus, cause the apparatus to perform the actions.

One Example includes a down pressure system, including: a plurality of row units affixed to a tool bar via linkages; a plurality of actuators disposed on the tool bar and in individual mechanical communication with the plurality of row units via the plurality of linkages; a plurality of valves disposed within a plurality of valve blocks constructed and arranged to be mounted on the tool bar via a valve bracket; a pressure line; and a return line, where each of the plurality of actuators are dual-acting actuators that include a bore chamber and rod chamber, and where the pressure line is in direct fluidic communication with the rod chambers and constructed and arranged to supply constant up pressure. Other embodiments of this Example include corresponding computer systems, apparatus, and computer programs recorded on one or more computer storage devices, each constructed and arranged to perform the actions of the methods.

Implementations may include one or more of the following features. The down pressure system where the plurality of valves are constructed and arranged to supply hydraulic pressure to the individual bore chambers so as to urge the plurality of row units via the linkages. The down pressure system where the pressure line is in fluidic communication with the plurality of valves to provide controlled down pressure to the bore chambers via a plurality of controlled pressure lines. The down pressure system where the valve block is coupled to the tool bar via a valve block bracket. The down pressure system where each of the plurality of actuators each includes an up pressure supply receiving port and a down pressure control receiving port that are in fluidic communication with the pressure line and valve, respectively. The down pressure system where the pressure line and return line are mounted to the tool bar via a line bracket. Implementations of the described techniques may include hardware, a method or process, or computer software on a computer-accessible medium.

One Example includes a down pressure system for a row unit, including: an actuator: a constant up pressure supply line in fluidic communication with the actuator and constructed and arranged to apply constant up pressure to the actuator; a valve disposed within a valve block constructed and arranged to be mounted on a tool bar; and a down pressure control line in fluidic communication with the valve and actuator so as to selectively supply down pressure to the actuator and urge the row unit downward. Other embodiments of this Example include corresponding computer systems, apparatus, and computer programs recorded on one or more computer storage devices, each constructed and arranged to perform the actions of the methods.

Implementations may include one or more of the following features. The down pressure system where the valve is in fluidic communication with a hydraulic system including supply and return lines, via a branched pressure line. The down pressure system where the actuator includes an up pressure supply receiving port and a down pressure control receiving port that are in fluidic communication with the up pressure supply line and down pressure control line, respectively. The down pressure system where the valve block includes a down pressure control supply port in fluidic communication with the valve. The down pressure system where the up pressure supply receiving port and down pressure control receiving port are disposed at the proximal end of the actuator. The down pressure system including a solenoid in electronic communication with a control module. The down pressure system where the actuator includes a ram including a fastener constructed and arranged to couple to a linkage bar. Implementations of the described techniques may include hardware, a method or process, or computer software on a computer-accessible medium.

One Example includes a down pressure system for a planter row unit, including: a line bracket constructed and arranged to be mounted to a tool bar and support a pressure line and a return line; an actuator constructed and arranged to be mounted to the tool bar and provide supplemental down pressure to the row unit via a linkage connection; a down pressure control line in operational communication with a valve; and a constant up pressure supply line, where the down pressure control line provides variable down pressure to the actuator, and where the constant up pressure supply line provides constant up pressure to the actuator. Other embodiments of this Example include corresponding computer systems, apparatus, and computer programs recorded on one or more computer storage devices, each constructed and arranged to perform the actions of the methods.

Implementations may include one or more of the following features. The down pressure system where the valve is housed in a valve block including a plurality of ports. The down pressure system where the actuator includes an up pressure supply receiving port and a down pressure control receiving port disposed at the proximal end of the actuator that are in fluidic communication with the up pressure supply line and down pressure control line, respectively. The down pressure system where the valve block is coupled to the tool bar via a valve bracket.

Implementations of the described techniques may include hardware, a method or process, or computer software on a computer-accessible medium.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a side view of an exemplary embodiment of the down pressure system installed on a planter row unit, according to one implementation.

FIG. 2 is a schematic view of a one implementation of the hydraulic down pressure system.

FIG. 3A is a graph depicting valve pressure and incremental up/down pressure.

FIG. 3B is a graph depicting net up pressure and down pressure relative to command percentage on a 4-way valve arrangement like that shown in FIG. 5C.

FIG. 4 depicts a further schematic view of one implementation of the hydraulic down pressure system.

FIG. 5A depicts a schematic view of one implementation of the hydraulic down pressure system having independent down pressure control of the actuators and constant up pressure.

FIG. 5B depicts a schematic view of another implementation of the hydraulic down pressure system having independent down pressure control of the actuators and constant up pressure.

FIG. 5C depicts a schematic view of another implementation of the hydraulic down pressure system having independent down pressure and up pressure control of the actuators.

FIG. 5D depicts a schematic view of another implementation of the hydraulic down pressure system having independent down pressure and up pressure control of the actuators via two valves per row unit.

FIG. 5E depicts a schematic view of another implementation of the hydraulic down pressure system having independent up pressure control of the actuators and constant down pressure.

FIG. 6A is a perspective view of a valve block, according to one implementation.

FIG. 6B is a rear view of a valve block, according to one implementation.

FIG. 6C is a top view of a valve block, according to one implementation.

FIG. 7A is a perspective view of an installed valve block, according to one implementation.

FIG. 7B is a further perspective view of an installed valve block, according to one implementation showing the connected hoses.

FIG. 8A is a side view of a row unit according to one implementation of the down pressure system.

FIG. 8B is a detailed perspective view of the implementation of FIG. 8A, showing the actuator and valve bracketed to the tool bar.

FIG. 8C is a detailed side view of the implementation of FIG. 8A, showing the actuator and valve bracketed to the tool bar.

FIG. 8D is a further detailed perspective view of the implementation of FIG. 8A, showing the actuator and valve bracketed to the tool bar.

FIG. 9A is a schematic diagram of the hydraulic system distribution, according to certain implementations.

FIG. 9B is a further schematic diagram of the hydraulic system distribution, according to certain implementations.

FIG. 10A is a perspective view of a distribution valve manifold, according to one implementation.

FIG. 10B is a further perspective view of a distribution valve manifold of FIG. 10A, showing additional bracketing.

### DETAILED DESCRIPTION

The various embodiments disclosed or contemplated herein relate to devices, methods, and design principles allowing for the application of net down pressure to individual row units in high speed planting applications. The various implementations disclosed herein relate to technologies for achieving down pressure and up lift control on a planter with independent row by row control capability. The implementations disclosed herein can be used in conjunction with any of the technologies and/or devices, systems and methods disclosed in U.S. Pat. No. 9,964,559 issued May 8, 2018 and Co-Pending U.S. application Ser. No. 15/972,330 filed May 7, 2018 which are incorporated by reference in their entireties here.

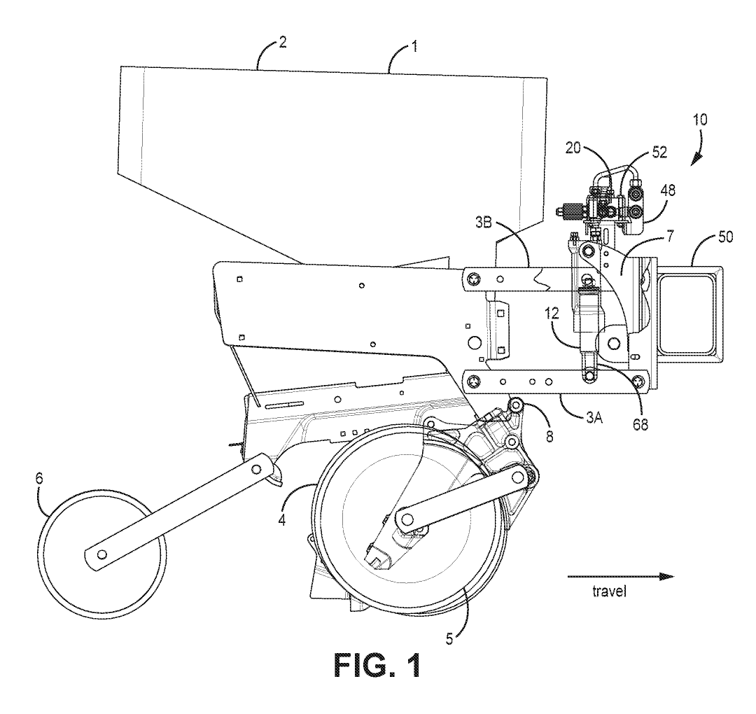

FIG. 1 depicts a planter row unit 1 having a hopper 2. The row unit 1 is deployed on a tool bar 50 via linkages 3A, 3B. The row unit 1 according to these implementations comprises gauge wheels 4, opening discs 5 and closing discs 6, as is understood in the art. In these implementations, an actuator 12 is disposed on the tool bar 50 via a bracket or brackets 7 so as to be in mechanical communication with the linkages 3A, 3B and selectively apply supplemental force to the row unit 1 through the parallel linkage 3A arms.

A load cell 8 is also disposed on and is in operational communication with the row unit 1, as is an electronic controller (not shown), as would be understood by those of skill in the art. These and the other various components of the row unit 1 and down pressure system 10 described herein are understood to be capable of electrical communication with an operations system, disposed elsewhere on the planter, implement or remotely, according to various implementations, as understood by those of skill in the art and as described in the incorporated references.

As described herein, in certain implementations, down pressure is selectively supplied to the row unit 1 hydraulically, while up force is provided constantly, thereby resulting in a down pressure system 10. It is understood that these up pressure and down pressure forces are applied to either side of the actuator 12 piston, but that other factors are included in the overall net downforce caused by the summed total of the applied down pressure, applied up pressure and other physical characteristics of the cylinder. The actuator 12 in turn provides supplemental downforce to the row unit 1, as is understood.

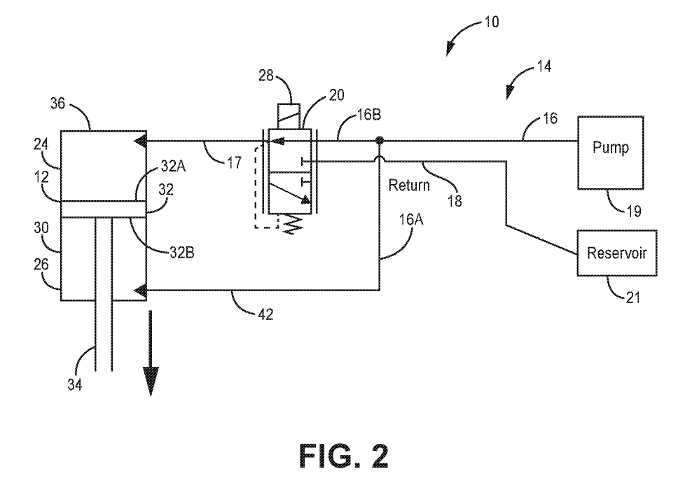

In certain implementations of the down pressure system 10, and as shown in FIG. 2, a dual-acting hydraulic actuator 12 is in fluidic communication with a hydraulic system 14 having a pressure line 16 and return line 18. In various implementations, the pressure line 16 is fed from a variable displacement hydraulic pump 19 as would be typically found in a tractor. In these implementations, the pressure line 16 is a full pump pressure line 16 and the return line 18 is a low pressure drain back to the hydraulic reservoir 21. Other configurations are of course possible.

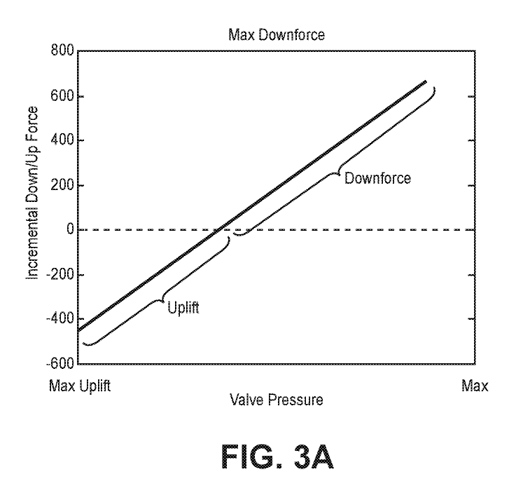

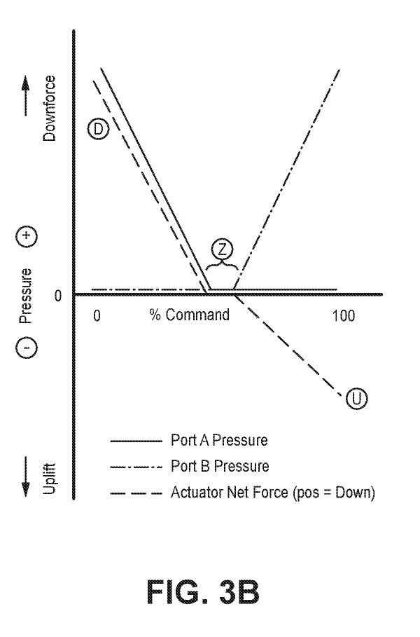

As is shown in FIG. 2 and described further below, in these and other implementations, the pressure line 16 bifurcates into an “up” supply 16A that is routed directly into the actuator 12 and a “down” supply 16B that is routed through a valve 20 to provide controlled down pressure 17. In various implementations, a constant supply of up pressure is thereby provided via the uplift line 16A, such that the control of the down pressure on the row unit 1 is controlled by the valve 20 and selective application of down pressure, as is depicted in FIG. 3A and would be appreciated by those of skill in the art for the various implementations of the system 10.

It is understood that in alternate implementations, the pump 19 can be mounted elsewhere, such as on the planter and be driven by a mechanical PTO shaft. In certain prior approaches, these variable displacement pumps are load sensing pumps, constructed and arranged to receive a sensed pressure from the actual load and adapt flow to maintain a constant differential pressure across a valve opening, to supply only the flow commanded by the amount of opening in the control valve—with the intent to supply the requested flow at a pressure 100-300 PSI above that required by the load, for energy efficiency.

Exemplary embodiments of the down pressure system 10 command the tractor valve (or other input source) to deliver more flow than the planter system 10 will use, which causes the pump to operate at its maximum allowed pressure—typically about 150 bars in metric, or about 2900 PSI in imperial units. Other amounts are of course contemplated given the range of pressures available from tractors, pumps and the like.

The pump 19 according to these implementations then controls its displacement to provide only the flow that the total down pressure system 10 will take when supplied with maximum pump pressure. It is understood that pump displacement is controlled by a built-in valve (not shown) that operates hydraulically/mechanically to change its displacement to keep pressure from exceeding maximum system design pressure of the tractor, as would be readily appreciated by those of skill in the art.

As is shown in FIG. 2, in certain implementations, a valve 20 is disposed on the tool bar 50 that is constructed and arranged to balance the force applied by an electro-mechanical solenoid 28 against the controlled pressure acting on the end of a valve spool inside the control valve. It is understood that such proportional pressure-reducing and relieving valves 20 are commercially available from many valve manufacturers, and are usable for any hydraulic function where it is desired to control a hydraulic pressure generally proportional to a voltage or a controlled current applied to the solenoid 28.

It is further understood that in various implementations, each of the valves is in operational and/or electrical communication with a row control module (RCM). In various implementations, the RCMs can be disposed on the individual row units, on the tool bar or elsewhere on the planter as would be understood. The RCMs of these implementations are constructed and arranged to provide commands to the various valves described herein via controlled current and other electrical signals.

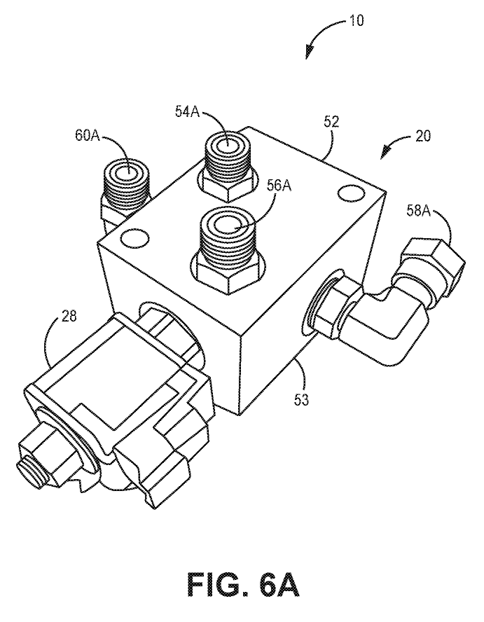

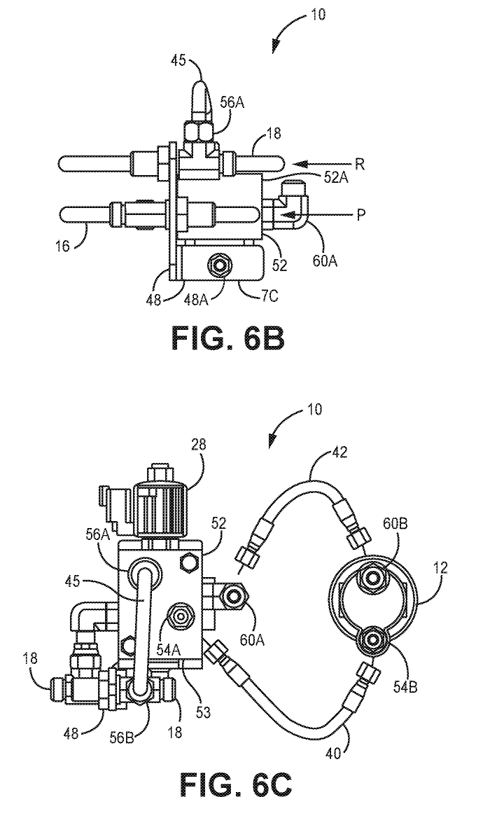

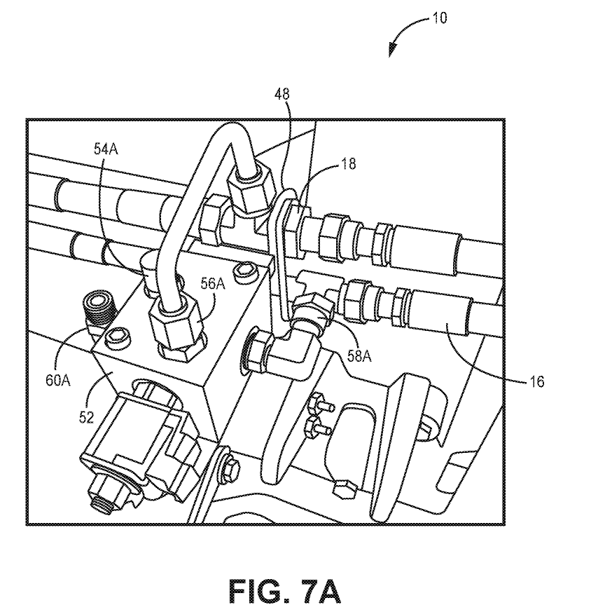

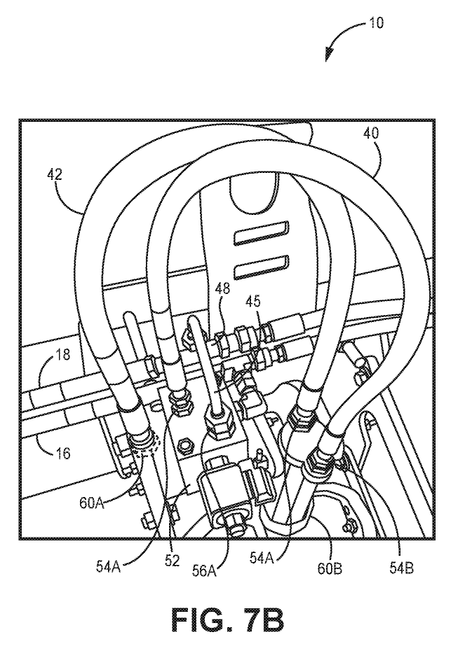

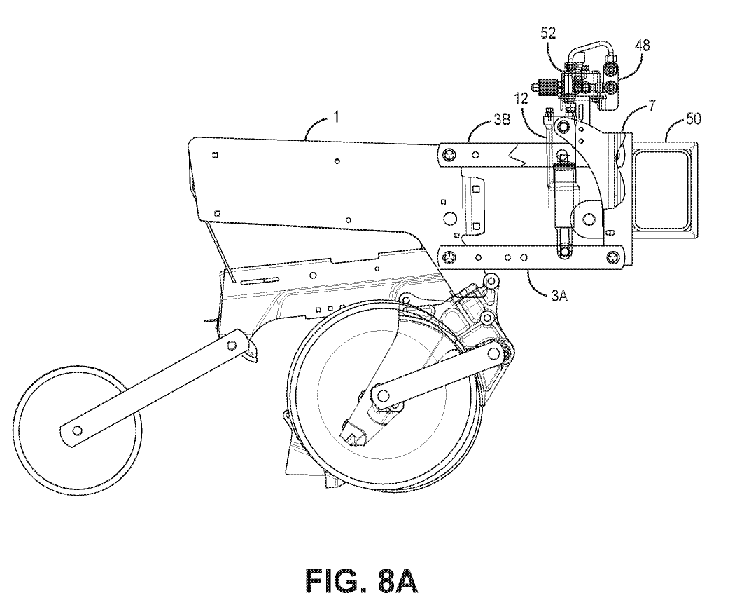

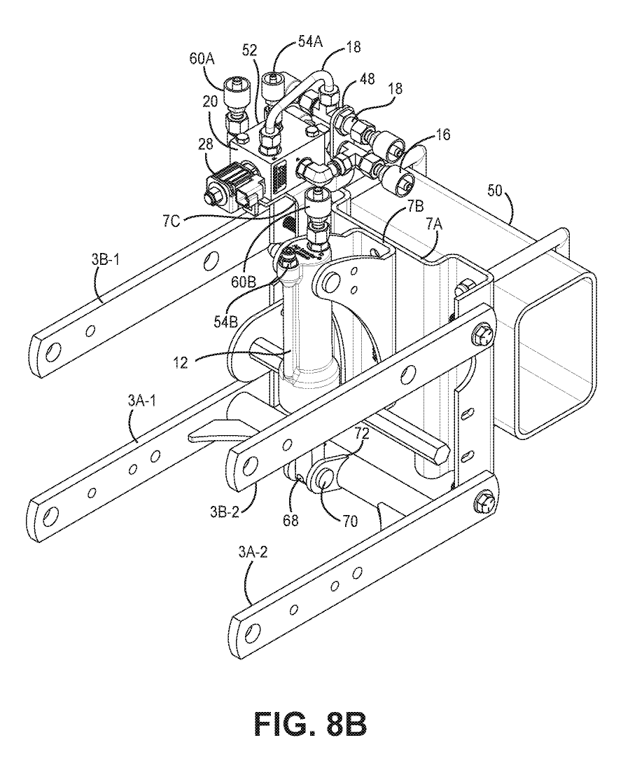

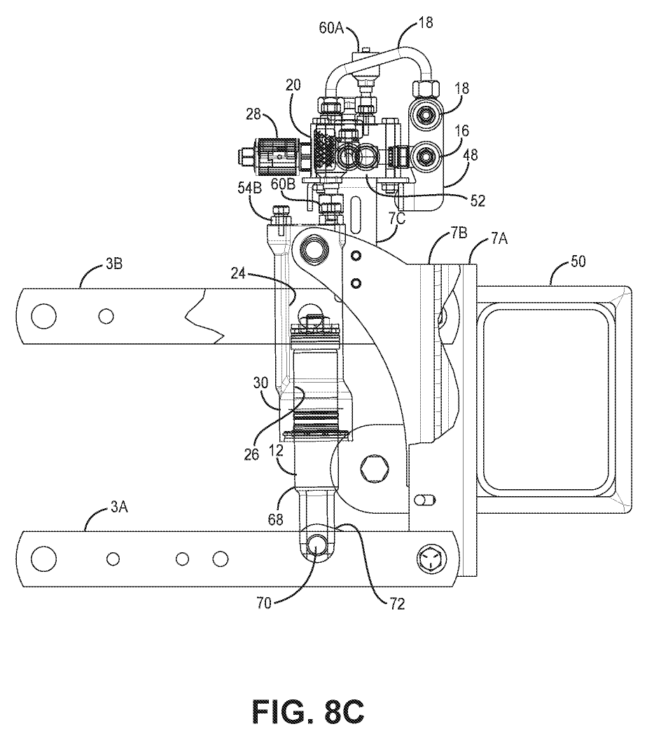

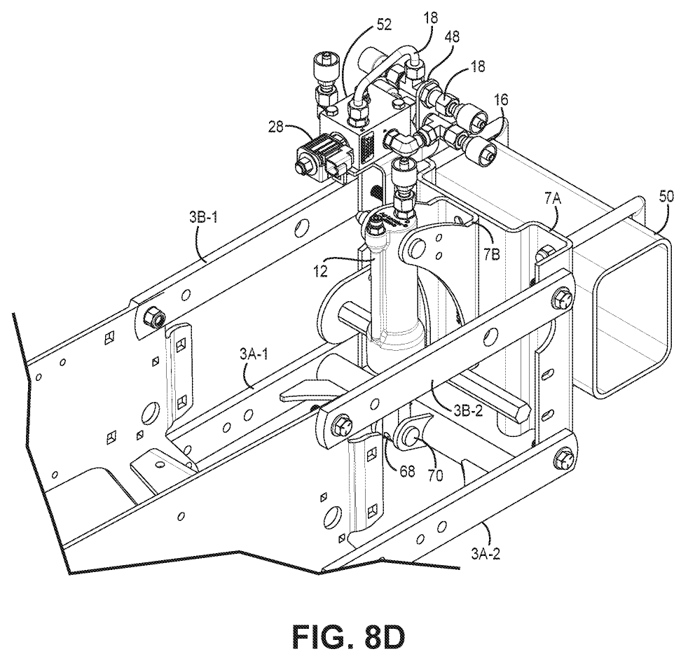

In various implementations of the system 10, the valve 20 utilizes controlled current, because the force exerted by the solenoid is proportional to current. In various implementations, this valve 20 is mounted on the tool bar, in a valve block that has multiple external ports for hose connections, as is also shown below in FIG. 6A, FIG. 6B, FIG. 6C, FIG. 7A, FIG. 7B, FIG. 8A, FIG. 8B, FIG. 8C and FIG. 8D.

Continuing with FIG. 2, in these implementations, the actuator 12 has a cylinder 30 having a piston 32 on a rod 34 disposed therethrough, as would be understood by one of skill in the art. In these implementations, the cylinder is a dual-acting cylinder 30 comprising a down pressure or upper chamber 24 and a lift, up pressure or lower chamber 26, both in fluidic communication with the hydraulic system 14.

In these and other implementations, the down pressure from the pressure line 17 is applied to the actuator 12 via fluid through a hose 40 coupled to the top (or head) end 36 of the cylinder 30 that is in fluidic communication with the valve 20. The down pressure supplied by the hose 40 exerts a downward force on the piston 32 in the cylinder 30. In these implementations, down pressure is controlled by the electrically actuated valve 20 that injects or releases flow from the head end 36 of the cylinder 30 by connecting the controlled pressure port of the valve 20 to either the pressure 16 or the return line 18.

The known prior art systems having uplift capability require a net flow from the pressure line that is the area of the piston multiplied by the speed of the rod. Since the annular area that creates uplift must be non-zero, it is impossible for the prior art systems to have a piston diameter that is equal to the rod diameter, forcing those systems to use a larger piston diameter to meet the design targets for both down pressure and uplift force.

It is understood that for a single-acting actuator according to these prior art systems to urge the cylinder piston and rod downward to maintain sufficient down pressure, less flow is required because the net flow from the supply pressure is only the area of the rod×the speed of the rod, because the flow of oil out of the annular area adds to oil supplied from the pump through the pressure line 16.

The known prior art systems require a net flow from the pressure line that is the area of the piston multiplied by the speed of the rod. As the annular area that creates uplift must be non-zero, it is impossible for the prior art system to have a piston diameter that is equal to the rod diameter, forcing it to use a larger piston diameter to meet the design targets for both down pressure and uplift force.

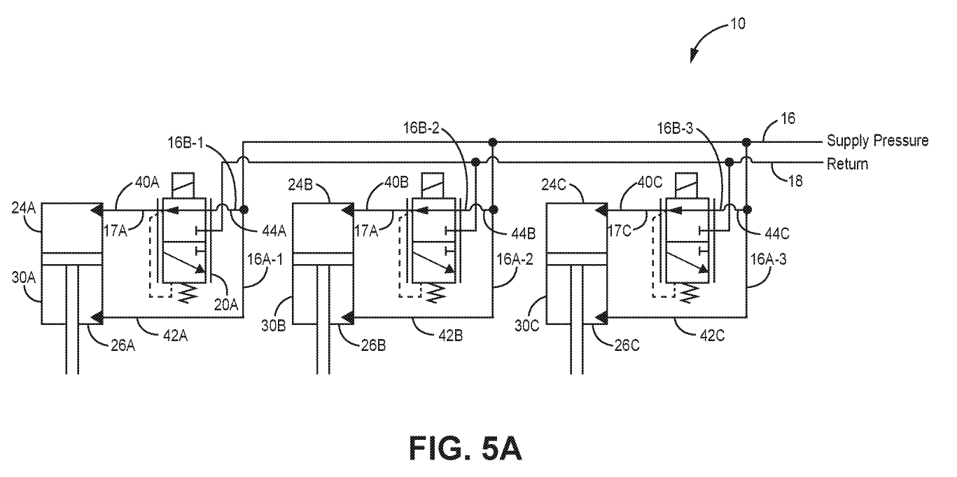

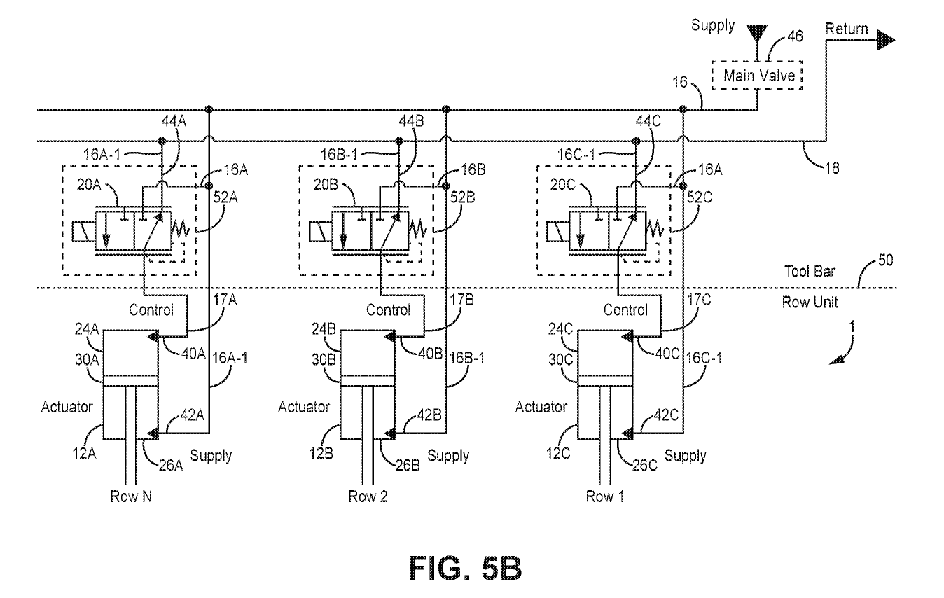

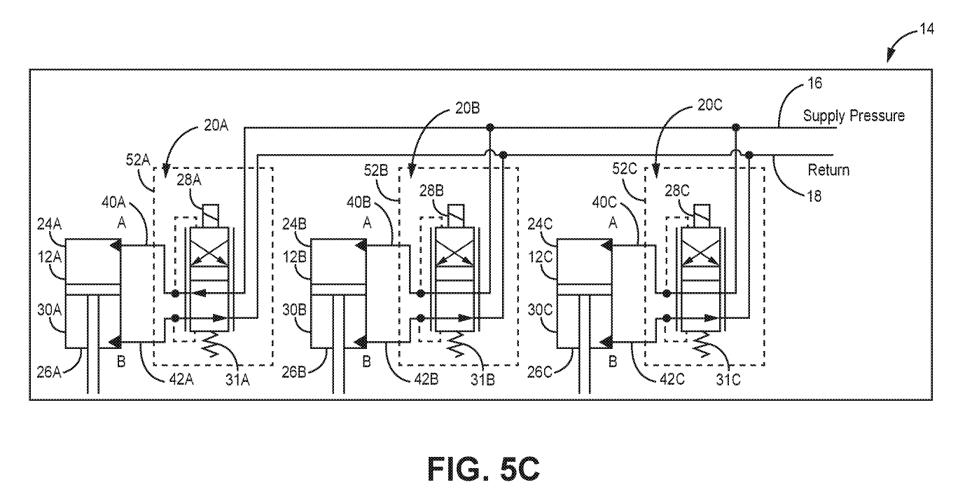

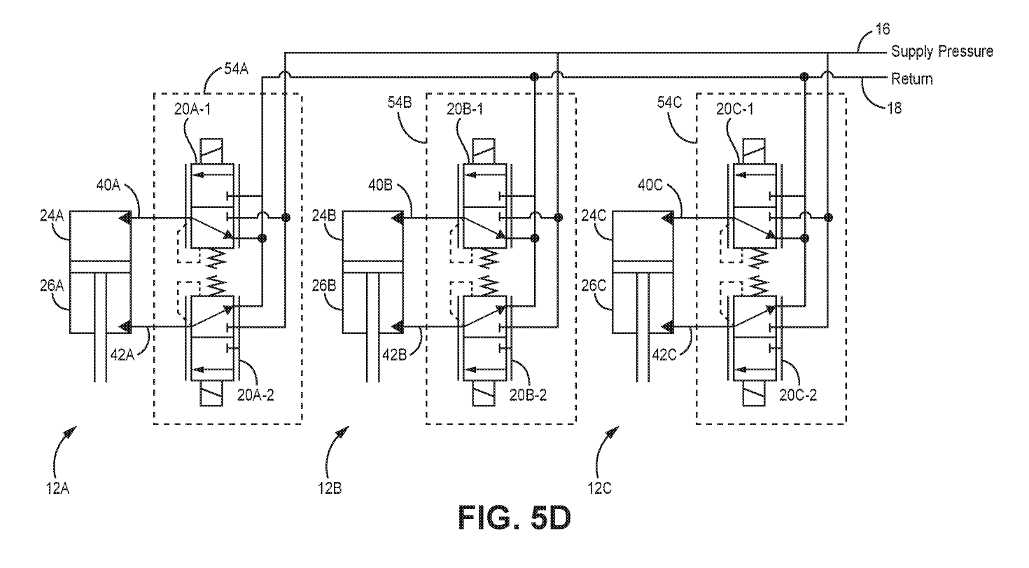

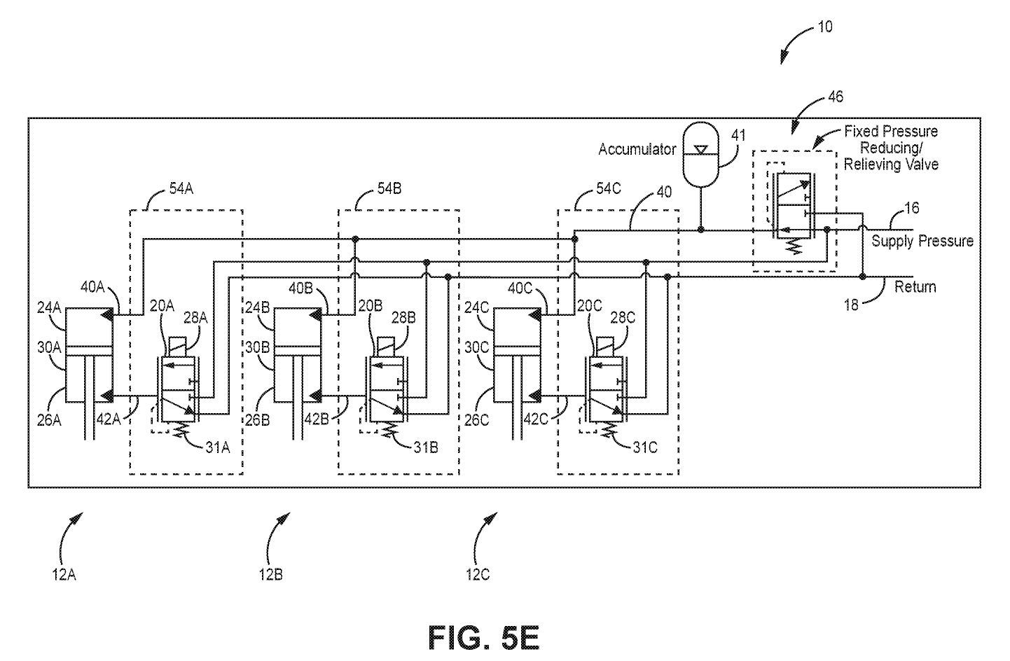

Various implementations of the down pressure system 10 utilizing proportional pressure-reducing and relieving valves and double acting cylinders are illustrated by the graph in FIG. 3A—and below in the implementations of FIG. 5A, FIG. 5B, FIG. 5D and FIG. 5E. In these implementations, uplift pressure is applied to the cylinder 30 via direct hydraulic flow into the bottom (or rod) end of the down pressure/uplift cylinder 30 through a hose 42 in fluidic communication with the pressure line 16, and exerts a constant upward force on the annular area 32B between the diameter of the piston 32 in the cylinder 30 and the diameter of the rod 34 that extends out of the cylinder 30. Thus, uplift force on the bottom of the cylinder (shown at 32B) for these implementations is always constant as given by:

(Annular Area)×(Pump Pressure)

Because the area of the top 32A of the piston is greater than the annular area 32B of the rod end of the cylinder 30, down pressure can always overcome uplift pressure to create a net down pressure on the piston 32 and therefore the row unit (shown, for example, in FIG. 1). Net uplift force is created when the pressure on the top 32A of the piston is reduced below the value given by:

(Pump Pressure)×(Annular Rod End Area)/(Top End Piston Area)

It is therefore understood that by constructing, arranging and sizing the diameters of the rod 34 and the piston 32, with knowledge of the maximum down pressure and uplift force requirements as given by the pump, row unit and other constant factors, the cylinder 30 design can be optimized in a method as follow.

In exemplary implementations, the rod 34 diameter (shown for example in FIG. 2) can be constructed and arranged such that:

(Maximum Down Pressure)=(Pump Pressure)×(Rod Area)

It is understood that because with system pressure on both the top and the bottom of the piston, the net force on the annular area is zero.

In these implementations, the piston 32 diameter is constructed and arranged such that:

(Maximum Uplift Force)=(Pump Pressure)×(Annular Area Between Piston And Rod Diameters)

Alternate implementations utilize 4-way proportional pressure reducing/relieving valves, are shown in the graph of FIG. 3B—and below in the implementation of FIG. 5C. In these implementations, the percent command current applied to the valve 20 causes either port A (solid line), B (dash-dot line)—the upper and lower valves in the example of FIG. 5C—to apply pressure to the cylinder at the bore or rod chamber, respectively, thereby resulting in a corresponding change in downforce or uplift, (a dashed line), as plotted on the y-axis. That is, in these implementations, down pressure is achieved when the percentage of command current applied to port A causes a sufficient supply of pressure to the corresponding bore chamber 24A, 24B, 24C to urge the actuator 12 distally or downward (shown at reference letter D). Similarly, proximal movement or uplift is achieved where sufficient force is applied via port B, as is shown at reference letter U.

In various implementations, and as is also shown in FIG. 3B, a dead band (shown at reference arrow Z) is present between the uplift and down pressure application areas. It is understood that a dead band can be desirable, as the dead band allows for dimensional tolerances in the manufacture and operation of the valves and actuator, as well as accommodation of variations in solenoid forces and command curves. As would be appreciated by one of skill in the art, a so-called “perfect V” would be difficult and costly to achieve and could lead to operational difficulties in real-world practice. It is appreciated that cartridge-style valves are used in certain implementations, other valve styles may be used in alternate embodiments.

Further, it is understood that in these implementations, the pressure in the bore end of the cylinder 22 does not have to be greater than the pressure in the rod end chamber 26 to create down pressure, thus the cylinder 22 diameter can be made smaller than a cylinder used in a system with constant supply pressure connected to the rod side, as was described in the previously described system incorporated by reference herein.

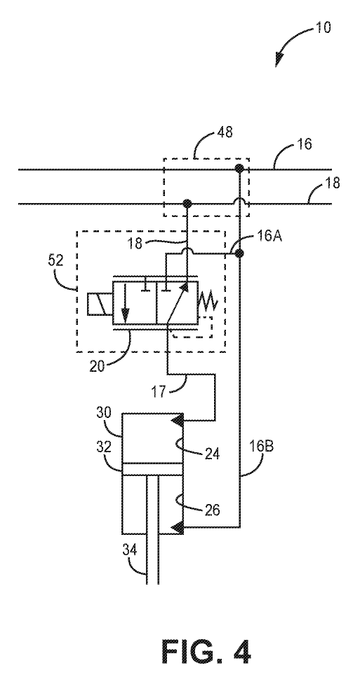

FIG. 4 depicts an implementation of the system 10 wherein the pressure 16 and return 18 lines are fluidically connected with the cylinder 30. The pressure line 16 and return line 18 running parallel to and atop the tool bar 50, tee-junctions and other joints are employed to branch those lines 16, 18 to the valve block 52 and actuator 12, as required.

In implementations such as these, the pressure line 16 is in fluidic communication with the valve 20 via first branch pressure line 16A and with the lift chamber 26 via a second branch, which is a constant up pressure line 16B. The valve 20 is in turn in direct fluidic communication via a control, or down pressure control line 17 to provided variable down pressure. In these implementations and others, the valve 20 is disposed within a valve block 52.

As is shown in FIG. 5A, FIG. 5B, FIG. 5C, FIG. 5D and FIG. 5E, several actuator cylinders 30A, 30B, 30C can be supplied via the pressure 16 and return 18 lines routed through several hoses 40A, 40B, 40C, 42A, 42B, 42C through a variety of configurations. Other variations and embodiments are of course contemplated.

FIG. 5A, FIG. 5B, FIG. 5C, FIG. 5D and FIG. 5E depict various implementations of the down pressure system 10. It is understood that in these and other implementations, a plurality of individual actuators 12A, 12B, 12C are provided that are each in mechanical communication with a row unit 1 to selectively apply vertical force to the row unit. In the implementations of FIG. 5A and FIG. 5B, a constant supply of upforce pressure is provided directly from the pressure line 16 to the lift chamber 26A, 26B, 26C. In implementations like that of FIG. 5C and FIG. 5D, variable up pressure and down pressure are provided. And in implementations like that of FIG. 5E, variable up pressure is provided. It is understood that many variations are possible.

As shown in FIG. 5A, FIG. 5B, FIG. 5C, FIG. 5D and FIG. 5E, each actuator 12 cylinder 30 is in fluidic communication with the hydraulic system 14 having a pressure line 16 and return line 18 in fluidic communication with a pump and reservoir (shown in FIG. 2). The pressure line 16 and return line 18 running parallel to and atop the tool bar 50, tee-junctions and other joints are employed to branch those lines 16, 18 to the valve block 52 and actuator 12, as required. In certain of these implementations, it is understood that the pressure line 16 is a full pump pressure line and the return line 18 is a low pressure drain back to the hydraulic reservoir 21, as shown above in FIG. 2.

In the implementations of FIG. 5A, FIG. 5B, FIG. 5D and FIG. 5E, the system 10 utilizes proportional pressure-reducing and relieving valves. In systems 10 like that of FIG. 5C, each actuator comprises a cylinder 30A, 30B, 30C that is in in fluidic communication with a single 4-way proportional pressure reducing/relieving valve 20A, 20B, 20C. While proportional pressure reducing-relieving valves are utilized in the depicted implementation, one of skill in the art would appreciate that various other known valve types constructed and arranged to achieve the desired pressure application can be used in alternate implementations.

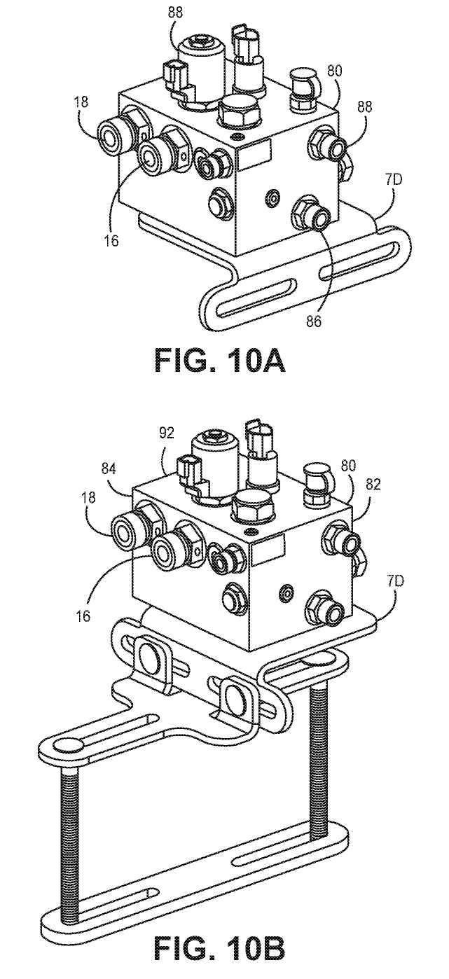

It is further understood that in these and the other implementations disclosed herein, the valves 20A, 20B, 20C can be mounted on the planter tool bar 50, in a valve block 52 that has multiple external ports for hose connections, as was described and shown in FIG. 6A, FIG. 6B, FIG. 7A and FIG. 7B. In alternate implementations, the valves 20 and valve blocks 52 can be mounted elsewhere about the row unit 1 and planter (shown in FIG. 10A and FIG. 10B at 100).

As would be understood by one of skill in the art, in various of the implementations of FIG. 5A, FIG. 5B, FIG. 5C, FIG. 5D and FIG. 5E the various valves 20A, 20B, 20C can be constructed and arranged to control the pressure applied to various chambers 24A, 24B, 24C, 26A, 26B, 26C in several different constant or variable ways. Therefore, according to these embodiments, the force applied to the row unit 1 by each actuator 12A, 12B, 12C can be adjusted by controlling either the pressure to the bore, or upper cylinder chamber 24A, 24B, 24C and rod, lift, up pressure or lower cylinder chamber 26A, 26B, 26C, or both, and therefore the force applied by each actuator 12A, 12B, 12C to the row unit 1.

In the implementations of FIG. 5A, FIG. 5B, FIG. 5C, FIG. 5D and FIG. 5E, where necessary, the force control is therefore continuously variable to be proportional to the commanded current in the valve 20A, 20B, 20C in the valve solenoid coils or operators 28A, 28B, 28C such that the force in each actuator 12A, 12B, 12C can be individually controlled.

As would be understood, in various implementations like those of FIG. 5A, FIG. 5B, FIG. 5C, FIG. 5D and FIG. 5E, the valves 20A, 20B, 20C comprise solenoids or operators 28A, 28B, 28C in operational communication with valve blocks 52A, 52B, 52C and springs 31A, 31B, 31C, though other configurations are of course possible. These springs 31A, 31B, 31C are shown in detail in FIG. 5C, and can be integral to each of the implementations disclosed or otherwise contemplated herein. It is further understood that the individual control of the valves 20A, 20B, 20C can be achieved via electronic control components understood and known in the art.

Importantly, the uplift and down pressure control of each individual actuator 12A, 12B, 12C is achieved in the implementations of FIG. 5A and FIG. 5B via individual control of the individual valves 20A, 20B, 20C applying active down pressure to offset and overcome the constant supply of up pressure. That is, in these implementations, the individual actuators 12A, 12B, 12C are constructed and arranged for discrete and individual application of down pressure. As would be appreciated by one of skill in the art, the selective application of down pressure can improve overall performance and crop yield.

In the implementations of FIG. 5A and FIG. 5B, the supply lines 16 are in direct fluidic communication with the lower chambers 26A, 26B, 26C via a direct constant up pressure supply lines 16A-1, 16A-2, 16A-3 carried through hoses 42A, 42B, 42C. The supply line 16 is also in fluidic communication with the valves 20A, 20B, 20C via lines 16B-1, 16B-2, 16B-3 routed through more hoses 44A, 44B, 44C. The valves 20A, 20B, 20C in turn route down pressure control lines 17A, 17B, 17C routed through additional hoses 40A, 40B, 40C to be in fluidic communication with the upper chambers 24A, 24B, 24C.

In implementations like that of FIG. 5B, the valve blocks 52A, 52B, 52C are mounted to the tool bar 50, and the pressure supply line hoses 42A, 42B, 42C are routed directly around the blocks 52A, 52B, 52C to directly supply constant fluid flow to the uplift chambers 26A, 26B, 26C.

In various implementations, and as shown in FIG. 5C, the individual valves 20A, 20B, 20C have control pressure lines 40A, 40B, 40C that are in fluidic communication with the bore, or upper chambers 24A, 24B, 24C as well as lower supply line hoses 42A, 42B, 42C that are in fluidic communication with the lower chambers 26A, 26B, 26C via ports (as shown in FIG. 6C, FIGS. 7A and 7B and elsewhere), as would be understood by one of skill in the art so as to supply or exhaust the desired pressure to the respective chambers 24A, 24B, 24C, 26A, 26B, 26C.

In the implementation of FIG. 5C and elsewhere, the springs 31A, 31B, 31C can be biased to produce down pressure with no current command, and one of skill in the art would readily appreciate that the various port A, B connections can be reversed to bias the supply for uplift as well for alternate applications. Various implementations are of course possible, wherein the springs 31 are calibrated to provide any resting point or response against the spool in response to a lack of command and/or amounts of command received thereby covering the entire range of operable down and up pressure points.

FIG. 5D depicts yet a further implementation of the down pressure system 10. In this implementation, the system 10 comprises two valves 20A-1, 20A-2 disposed within a single valve block 52 per actuator 12, such that the upper valve 20A-1 is in fluidic communication with the bore chambers 24A, 24B, 24C via control pressure lines 40A, 40B, 40C and the second valve 20A-2 is in fluidic communication with the rod chamber 26A, 26B, 26C via lift control pressure lines 42A, 42B, 42C. It is understood that in these configurations, the system 10 is constructed and arranged such that it is possible to control the pressures in the various chambers 24, 26 of the down pressure actuator on each row, and therefore the net actuator force via a separate pressure reducing/relieving valve 20A-1, 20A-2, on each side of the actuator 12.

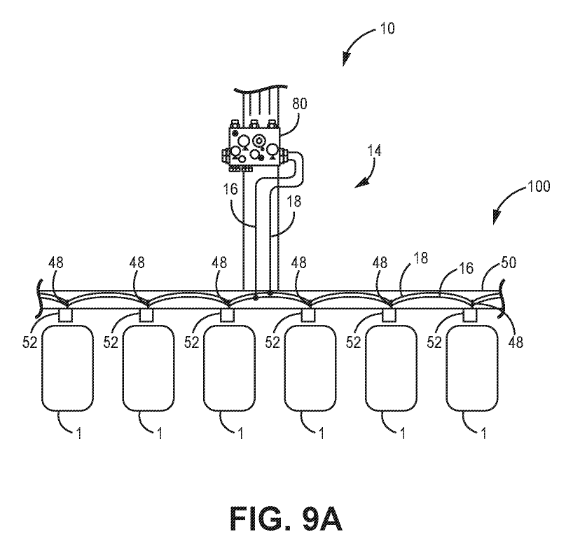

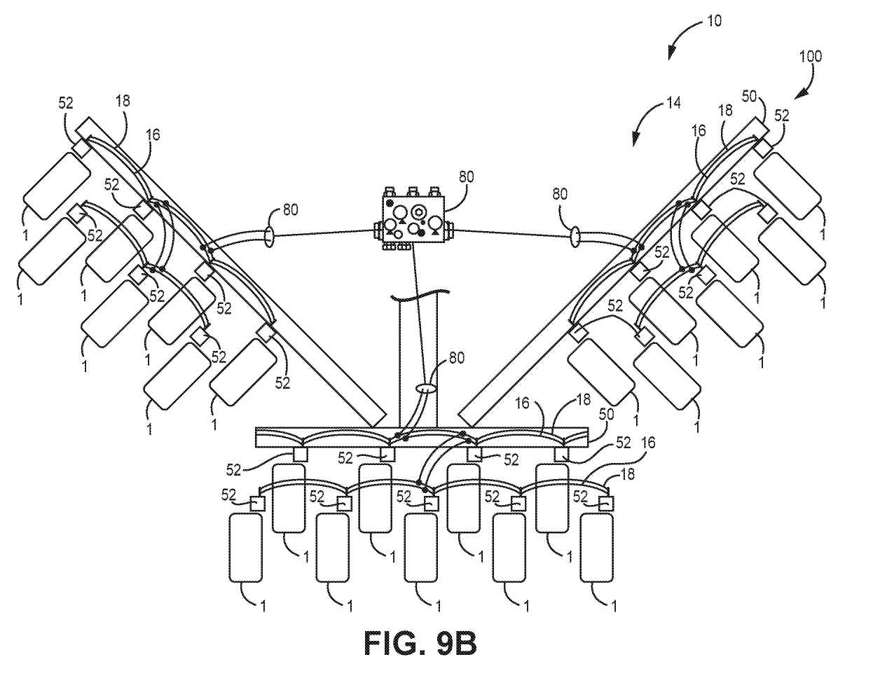

It is understood that the implementations of FIG. 5A, FIG. 5B, FIG. 5C and FIG. 5D provide numerous advantages, including the independent control of net force on each actuator 12 and therefore corresponding row via a single valve 20 and control output per row. Further, this reduces the overall cost of the unit, as it requires only two hoses 40, 42 per cylinder from each row valve 20 in certain of these implementations. Further, according to certain of these implementations, only two hose or line runs (pressure 16 and return 18) need be routed from the central hydraulic supply (shown, for example in FIG. 9A and FIG. 9B) to the individual valves 20 mounted to the tool bar 50 adjacent to each row unit 1 on the planter.

It is understood that when the actuator 12 needs to move the cylinder piston and rod downward to maintain sufficient down pressure, less flow is required, because the net flow from pressure is only the area of the rod multiplied by the speed of the rod, because the flow of oil out of the annular area adds to oil supplied from the pump through the pressure line, as discussed above.

In contrast to the above implementations, in the system 10 shown in FIG. 5E, the bore, or upper cylinder chambers 24A, 24B, 24C are in direct fluidic communication with a constant pressure line 40A, 40B, 40C via a plurality of down pressure ports. In the implementation of FIG. 5E, the rod, or lower cylinder chambers 22A, 22B, 22C are in fluidic communication with individual controllable pressure reducing/relieving valves 20A, 20B, 20C via control pressure lines 42A, 42B, 42C. As would be apparent to one of skill in the art, in these implementations, bore side pressure supplied by the constant pressure line 40 is substantially identical for all actuators 12A, 12B, 12C across the planter.

In these implementations, the constant pressure line 40 is in fluidic communication with an accumulator 41 as well as a fixed pressure reducing/relieving valve 46 disposed on the supply pressure line 16, though other implementations are possible.

In use according to these implementations, the pressure line 40 pressure is set via the fixed pressure reducing/relieving valve 46 to a level below the max pressure available to the controllable pressure reducing/relieving valves 20A, 20B, 20C connected the rod, or lower cylinder chambers 26A, 26B, 26C. Accordingly, the actuator areas and bore side pressure settings in these implementations are constructed and arranged to achieve a desirable range of net uplift and down pressure force levels, as has been previously described.

To reduce the flow demand from the tractor when the actuators extend, and as shown in the implementation of FIG. 5E, an accumulator 41 can be added to the pressure line to provide additional flow during peak demands. The accumulator 41 of these implementations will also reduce the exhaust flow requirement on the fixed pressure reducing/relieving valve 40 for the conditions when many actuators retract at one time, as would be understood by one of skill in the art.

Turning to various implementations of the valve 20 and valve block 52, FIG. 6A, FIG. 6B, FIG. 6C, FIG. 7A and FIG. 7B depict a valve block 52 containing at least one valve 20 that can be mounted to the tool bar 50 or elsewhere ahead of the row unit for operation of the actuator (shown in FIG. 2 and FIG. 5A). In various implementations, the valve block 52 is mounted to a valve bracket 7C, as is shown in FIG. 8B. It is understood that in these implementations, the valve block 52 is in electronic communication with one or more controls (not shown) such as a planter control module and/or row control module.

It is further understood that in these and other implementations, and as shown in FIG. 6A, the pressure 16 and return 18 lines are routed in parallel along the tool bar 50 and supported by a line bracket 48 that is disposed ahead of the valve block 52 and bolted or otherwise fastened to the valve bracket (shown elsewhere at 7C) via one or more fasteners 48A, as is also shown below in FIG. 8C. In these implementations, the lines 16, 18 are then routed to each valve block 52 and/or actuator 12 via a tee-connection or other fluidic communication stemming from the tool bar 50.

In certain implementations the valve block 52 can contain a single down pressure valve 20, as is shown for example in FIG. 5A, FIG. 5B, FIG. 5C and FIG. 5E. In alternate implementations, such as that shown in FIG. 5D, multiple valves 20A, 20B can be disposed within a single block 52.

In each of these implementations, and as shown in FIG. 6A, FIG. 6C and FIG. 7A, a first pressure port 54A is disposed on valve block 52 housing 53, along with a return port 56A and a supply intake port 58A. Further, an second pressure port 60A is provided. In various implementations, the first 54A and second 60A pressure ports are in fluidic communication with the pressure line 16 and/or valve 20 and can pass through the valve block 52 or bypass the valve block 52. It is understood that each valve block 52 can have fewer ports if some or all of the common connections were made with tees or elbows in the hose connections.

Accordingly, in these implementations, one pressure port 54A, 60A is connected to the output of the pressure control valve 20 within the valve block 52 to provide a down pressure control line via a hose 40, 42, as is shown in FIG. 6C, FIG. 7A and elsewhere.

The other pressure port 54A, 60A of these implementations provides a constant up pressure supply via direct fluidic communication with the uplift chamber of the actuator 12 via a up pressure supply receiving port which, in various implementations, is the first 54B or second 60B receiving port, via another hose 40, 42, so as to supply a constant supply of hydraulic uplift force, as is also shown in FIG. 6C and FIG. 7A.

In these implementations, the return port 56A and supply intake port 58A are in direct fluidic communication with the supply and return lines 16, 18 described above so as to provide fluidic communication with the valve 20 disposed within the block 52. In turn, the valve 20 is able to provide sufficient down pressure to urge the actuator 12 downward.

And as is also shown in the implementations of FIG. 6C, FIG. 7A and FIG. 7B, a variety of hoses 40, 42, tubes 45 and/or other fluidic connections can be used to route hydraulic fluid between the block 52, the actuator 12 and/or other components and the hydraulic pressure 16 and return 18 lines. It is appreciated and understood that each of the ports 54A, 54B 56A, 58A, 60A, 60B may be constructed and arranged to interact with the valve block 52 and/or actuator 12 and/or pressure 16 or return 18 lines so as to achieve the various hydraulic system implementations disclosed herein, particularly in relation to FIG. 2, FIG. 4, FIGS. 5A-5E and elsewhere. Further ports can of course be provided and configured in turn.

Turning to the system 10 implementations of FIG. 8A, FIG. 8B, FIG. 8C and FIG. 8D, the row unit 1 is coupled to the linkages 3A-1, 3A-2, 3B-1, 3B-2, which are coupled to the tool bar 50 via a tool bar bracket 7A. The body of the actuator 12 is in turn coupled to the tool bar 50 via an actuator bracket 7B coupled to the tool bar bracket 7A. The valve block 52 is in turn coupled to the tool bar 50 via a valve bracket 7C coupled to the tool bar bracket 7A or actuator bracket 7B. Finally, the line bracket 48 is coupled to the valve bracket 7C, as described in relation to FIG. 6A. It is well appreciated by the skilled artisan that each of the tool bar bracket 7A, actuator bracket 7B, valve bracket 7C and line brackets 48 are optional, and that each and every one of these brackets 7A, 7B, 7C, 48 can be fastened to one another and/or the tool bar 50 in various ways in certain implementations, and that each of these implementations is understood to be disclosed herein.

The actuator ram 68 according to these implementations is in mechanical communication with the lower linkages 3A-1, 3A-2 via a fastener 70 coupled to a linkage bar 72 through openings defined in brackets on either side of the linkage bar. It is understood that the extension and retraction of the ram 68 will urge the linkages 3A-1, 3A-2 distally or proximally, respectively via the linkage bar 72. It is further understood that many other linkage couplings are contemplated, as would be appreciated by those of skill in the art.

In implementations such as these, one pressure port 54A, 60A is a constant up pressure supply line that is in direct fluidic communication with the pressure line 16 and the lift chamber 26 of the actuator 12, as is shown in FIG. 2, FIG. 4, FIG. 5A and FIG. 5C.

In various implementations, a second pressure port 54A, 60A is a down pressure control line that provides control pressure via a hose (40, 42 as shown in FIG. 6C and FIG. 7A) to the a receiving port 54B, 60B disposed on the actuator 12 and in fluidic communication with the upper chamber 24 of the actuator 12 cylinder, as is also shown in FIG. 6C, FIG. 7A and FIG. 7B. In these implementations, the down pressure control line—such as is shown at 40 or 42—is in fluidic communication with a valve 20 so as to provide controlled down pressure to the actuator 12 via another port 54B, 60B, as is shown in FIG. 2, FIG. 4, FIG. 5A, FIG. 5B, FIG. 5C and FIG. 5D.

In alternate implementations, one pressure port 54A, 60A is in fluidic communication with the valve 20 so as to provide a controlled up pressure line, as is shown in FIG. 5C, FIG. 5D or FIG. 5E.

In yet further implementations, another port 54A, 54B is in fluidic communication so as to provide constant down pressure, as shown in FIG. 5E.

As shown in FIG. 9A and FIG. 9B, in certain implementations, a distribution valve manifold 80 is in operational communication with the various pressure 16 and return 18 lines distributed about the planter 100 on valve brackets 48 to provide the distribution of pump pressure to the valve blocks 52 mounted on the tool bar(s) 50 for use with the row units 1.

FIG. 10A and FIG. 10B depict one implementation of a distribution valve manifold 80 mounted to brackets 7D, 7E for use with the pressure 16 and return 18 lines of the system 10.

In certain implementations of the system, a planter control module (PCM) 82 disposed within or on or otherwise is in operational communication with the distribution valve manifold 80 so as to control the flow of fluid via a valve 84 disposed within the manifold 80 via several ports 16, 18, 86, 88. In various implementations, the PCM 82 is constructed and arranged to communicate with a centralized operating system, as would be understood. That is, the valve manifold 80 comprises a valve 84 and solenoid and a solenoid 90 operated shut off valve.

In certain implementations, the distribution valve manifold 80 and/or PCM 82 comprises a pressure sensor 92 constructed and arranged to monitor the hydraulic pressure level of the hydraulic system 14. It is understood that various operations of the planter and/or other factors may lead to variations in overall hydraulic system pressure, and therefore changes in the constant up pressure supply to the lift chambers. In turn, the amount of applied down pressure can be modulated via a control system. That is, in response to a change in the overall hydraulic system pressure, these implementations of the system are constructed and arranged to cause a corresponding increase or decrease in applied down pressure to offset the change in the amount of constant up pressure.

Although the disclosure has been described with reference to certain embodiments, persons skilled in the art will recognize that changes may be made in form and detail without departing from the spirit and scope of the disclosed apparatus, systems and methods.

What is claimed is:

1. A down pressure system, comprising:
(a) a plurality of row units affixed to a tool bar via linkages;
(b) a plurality of actuators disposed on the tool bar and in individual mechanical communication with the plurality of row units via the linkages;
(c) a plurality of valves disposed within a plurality of valve blocks constructed and arranged to be mounted on the tool bar via a valve bracket;
(d) a pressure line; and
(e) a return line,
wherein each of the plurality of actuators are dual-acting actuators that comprise a bore chamber and rod chamber, and
wherein the pressure line is in direct fluidic communication with the rod chambers and constructed and arranged to supply constant up pressure.

2. The down pressure system of claim 1, wherein the plurality of valves are constructed and arranged to supply hydraulic pressure to the bore chambers so as to urge the plurality of row units via the linkages.

3. The down pressure system of claim 1, wherein the pressure line is in fluidic communication with the plurality of valves to provide controlled down pressure to the bore chambers via a plurality of controlled pressure lines.

4. The down pressure system of claim 1, wherein the valve block is coupled to the tool bar via a valve block bracket or via an actuator bracket.

5. The down pressure system of claim 1, wherein each of the plurality of actuators each comprises an up pressure supply receiving port and a down pressure control receiving port that are in fluidic communication with the pressure line and valve, respectively.

6. The down pressure system of claim 1, wherein the pressure line and return line are supported by a line bracket.

7. A down pressure system for a row unit, comprising:
(a) an actuator;
(b) a constant up pressure supply line in fluidic communication with the actuator and constructed and arranged to apply constant up pressure to the actuator;
(c) a valve disposed within a valve block constructed and arranged to be mounted on a tool bar; and
(d) a down pressure control line in fluidic communication with the valve and actuator so as to selectively supply down pressure to the actuator and urge the row unit downward.

8. The down pressure system of claim 7, wherein the valve is in fluidic communication with a hydraulic system comprising supply and return lines, via a branched pressure line.

9. The down pressure system of claim 7, wherein the actuator comprises an up pressure supply receiving port and a down pressure control receiving port that are in fluidic communication with the up pressure supply line and down pressure control line, respectively.

10. The down pressure system of claim 9, wherein the valve block comprises a down pressure control supply port in fluidic communication with the valve.

11. The down pressure system of claim 9, wherein the up pressure supply receiving port and down pressure control receiving port are disposed at the proximal end of the actuator.

12. The down pressure system of claim 7, comprising a solenoid in electronic communication with a control module.

13. The down pressure system of claim 7, wherein the actuator comprises a ram comprising a fastener constructed and arranged to couple to a linkage bar.

14. A down pressure system for a planter row unit, comprising:
(a) a line bracket constructed and arranged to be mounted to a tool bar and support a pressure line and a return line;
(b) an actuator constructed and arranged to be mounted to the tool bar and provide supplemental down pressure to the row unit via a linkage connection;
(c) a down pressure control line in operational communication with a valve; and
(d) a constant up pressure supply line,
wherein the down pressure control line provides variable down pressure to the actuator, and
wherein the constant up pressure supply line provides constant up pressure to the actuator.

15. The down pressure system of claim 14, wherein the valve is housed in a valve block comprising a plurality of ports.

16. The down pressure system of claim 15, wherein the valve block is coupled to the tool bar via a valve bracket.

17. The down pressure system of claim 14, wherein the actuator comprises an up pressure supply receiving port and a down pressure control receiving port disposed at the proximal end of the actuator that are in fluidic communication with the up pressure supply line and down pressure control line, respectively.

18. The down pressure system of claim 14, wherein the pressure line and return line are in fluidic communication with a distribution valve manifold, a pump and a reservoir.

19. The down pressure system of claim 14, wherein the pressure line and return line are constructed and arranged to run in parallel along the tool bar.

20. The down pressure system of claim 14, wherein the valve is a proportional pressure-reducing and relieving valve.
